(19) United States
(12) Patent Application Publication
(10) Pub. No.: US 2008/0314217 A1
(43) Pub. Date: Dec. 25, 2008

(54) Cutting Tool For Cutting a Plate

(75) Inventor: Lionel Marcon, Domont (FR)

Correspondence Address: LEYDIG VOIT & MAYER, LTD, 700 THIRTEENTH ST. NW, SUITE 300, WASHINGTON, DC, 20005-3960, US

(73) Assignee: ETABLISSEMENTS PIERRE GREHAL ET CIE SA, Saint-Brice-Sous-Foret (FR)

(21) Appl. No.: 11/817,355

(22) PCT Filed: Jan. 6, 2006
(86) PCT No.: PCT/FR06/00028

§ 371 Date: Apr. 16, 2008

(30) Foreign Application Priority Data
Mar. 10, 2005 (FR) 0502395
Jul. 6, 2005 (FR) PCT/FR2005/001742

(51) Int. Cl. B26D 7/01; B26D 5/02; B26D 5/00

(52) U.S. Cl. 83/468.3; 83/477.2; 83/821

(57) ABSTRACT

A cutting tool for cutting a plate made of a reconstituted material, the tool comprising a base and a blade mounted on a support secured to the base and enabling the blade to be moved between an open position for receiving, between the support and the blade, a plate made of reconstituted material to be cut, and a closed position at the end of a cutting operation. The support includes a slot to receive the blade during the cutting process. The blade is flat and has a curved cutting edge. The tool also comprises a stop to maintain the plate on the support during the cutting process.

This invention relates to a cutting tool for cutting out a panel made of a reconstituted material.

In the field of new construction, building components are often used that are formed or reconstituted from materials that appear or are reduced to powder, fibers, granules or chips. Thus, as non-limiting examples, dry-wall panels, cement sheets or ceramic tiles are used as building or finishing components, fiber-cement cladding panels average-density cellulosic fiber panels as facing or finishing panels, and laminated sheets as floating floor components.

Due to the nature of the mixture of components from which the panels are made, or due to the use for which the panels are made, they have two characteristics in common: the hardness of the panel, or at the very least of its working surface, and its thickness.

Taken alone, each of these characteristics would not pose any particular problem in cutting out a panel made of one of the reconstituted materials mentioned. As a matter of fact, once availed of a cutting tool, the cutting edge of which is harder than the element being cut out, the success of the cut no longer depends on anything but the force that the operator of the tool is able to produce. Example: cutting out ceramic tiles (thus flooring tile). And, once availed of a cutting tool capable of passing through the entire thickness of the element being cut out without remaining stuck therein, it is possible to make the cut. Example: cutting out a particleboard work surface.

But, when the panels are made of a reconstituted material combining hardness and thickness, it is necessary to have a tool capable of overcoming these two cutting difficulties.

But the tool in question must also meet other requirements: the tool must be simple to use, easy to stabilize on a floor, in particular on a relatively uneven floor such as a floor outside the workshop. Furthermore, it would be useful for the tool to not be limited to a right-angled cut and for it to comprise a means of preventing the panel from being driven out of place by the blade of the cutting tool.

Thus, the purpose of the invention is to propose a cutting tool for cutting out a panel made of a reconstituted material, which meets the various requirements mentioned above.

The purpose of the invention is achieved with a cutting tool for cutting out a panel made of a reconstituted material, the tool including a base and a blade mounted movably on a support attached to the base and enabling the blade to be moved between an open position for receiving, between the support and the blade, a panel made of a reconstituted material that is to be cut out, and a closed position at the end of the cutting operation, the support being provided with a slot shaped for receiving the blade during cutting.

According to the invention, the blade has a back and a flat and curved cutting edge, and the support comprises a transverse stop intended to hold the panel being cut out on the support during cutting, so as to prevent the panel from being driven out of place by the blade in the direction of cutting.

Owing to this design of the invention, the blade, in cooperation with the edges of the slot in the base, performs a dual shearing operation, the result of which is that, during cutting, the blade does not as usual penetrate the material of the panel being cut out, but removes a strip of the material of the panel. The width of the strip corresponds substantially to that of the blade. Thus, the panel made of a reconstituted material is not deformed, since it is supported on either side of the blade by the two portions of the base situated on either side of the slot in the base. Furthermore, the panel being cut out is held on the base so as to not be capable of escaping ahead of the lowering blade. To that end, the tool includes either a separate stop or a stop that is built into the blade, as will become apparent from the description of two embodiments of the invention.

The invention also further relates to the following characteristics, considered separately or in any technically possible combination:

the cutting edge of the blade was obtained by a laser-cutting operation;

the curvature of the blade is determined so that, in any instantaneous position of the blade during cutting, the angle enclosed between the support and the blade is at least approximately constant;

the width of the slot is greater than the width of the blade;

when it is a separate element, the stop has a large width;

in this case, the width of the stop corresponds approximately to the length of the slot;

the stop is an element that is integral with the support mounted perpendicularly in relation thereto;

the stop comprises an adjustable distance stop enabling cuts to be made at various angles;

the stop is a separate element mounted angularly variable on the support;

the stop comprises a movable T-shaped slider enabling support of the reconstituted material that is to be cut out;

the base is extended in the direction of cutting by a foot ensuring stability of the tool in the direction of cutting and in a direction transverse thereto;

the blade is provided with a handle connected to the blade by a lever-forming arm;

the transitional portion from the blade to the arm is shaped so as to come to bear against the stop, at the end of the cutting operation, and so as to thereby limit the travel of the blade towards its closed position;

the blade is provided with a handle that is offset in relation to the back of the blade, so that, at the end of the cutting operation, the handle is situated at approximately the same level as the slot, or at a level lower thereto.

Other characteristics and advantages of this invention will become apparent from the following description of four embodiments of the tool according to the invention. The description is made in reference to the appended drawings, in which:

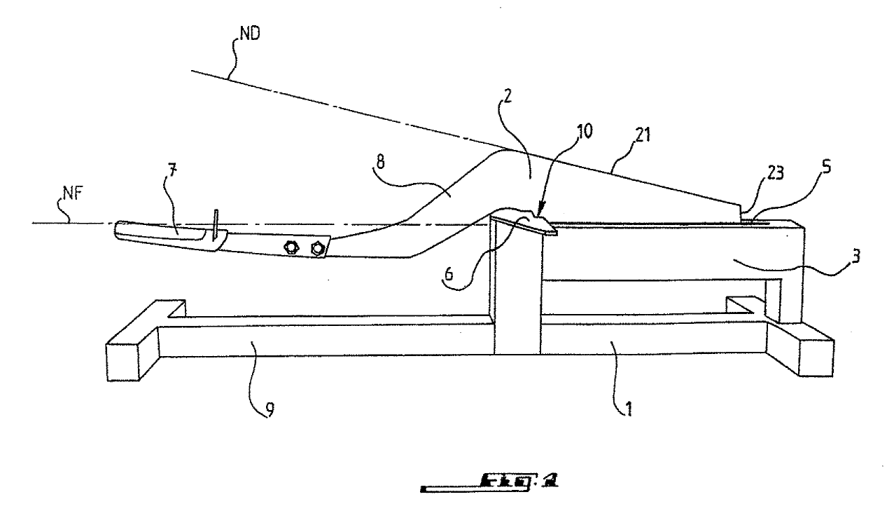

FIG. 1 shows a cutting tool according to a first embodiment of the invention, in closed position,

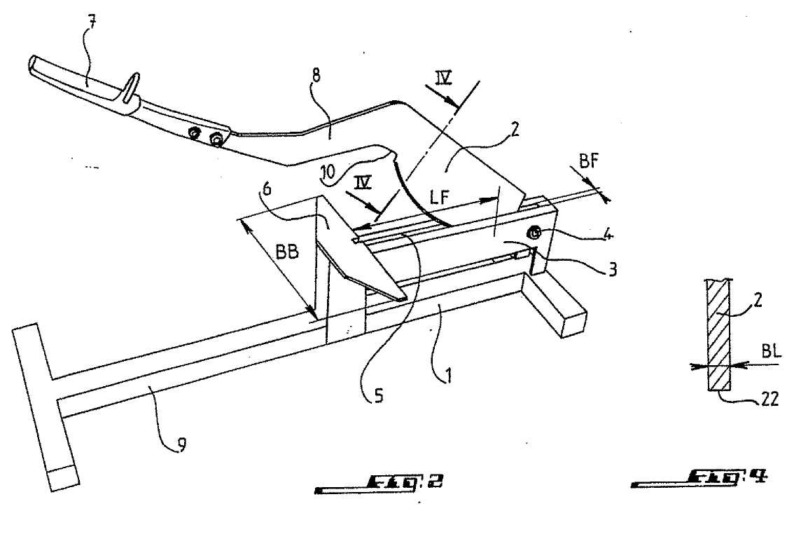

FIG. 2 shows the tool of FIG. 1 in half-open position,

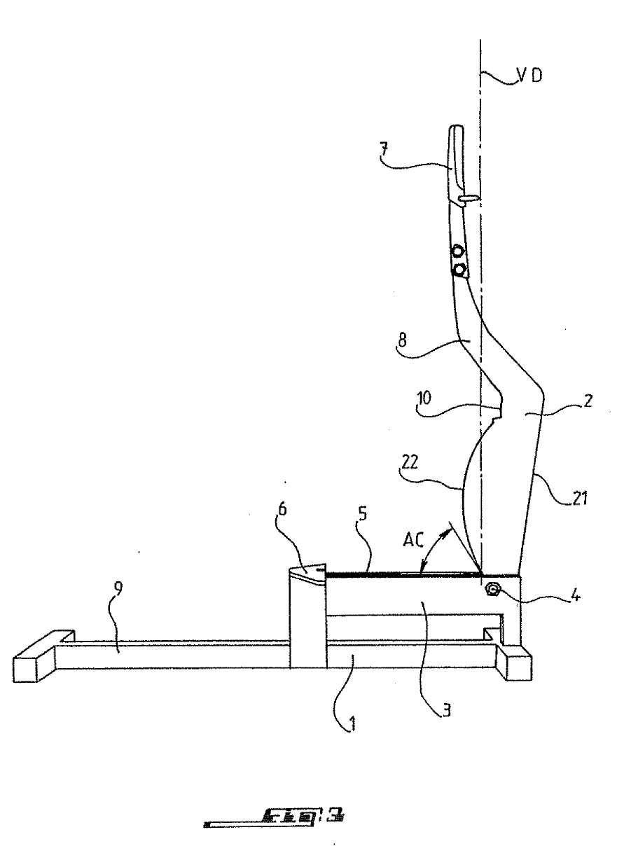

FIG. 3 shows the tool of FIG. 1 in open position,

FIG. 4 shows the blade of the tool as a cross-sectional view along line IV-IV of FIG. 3,

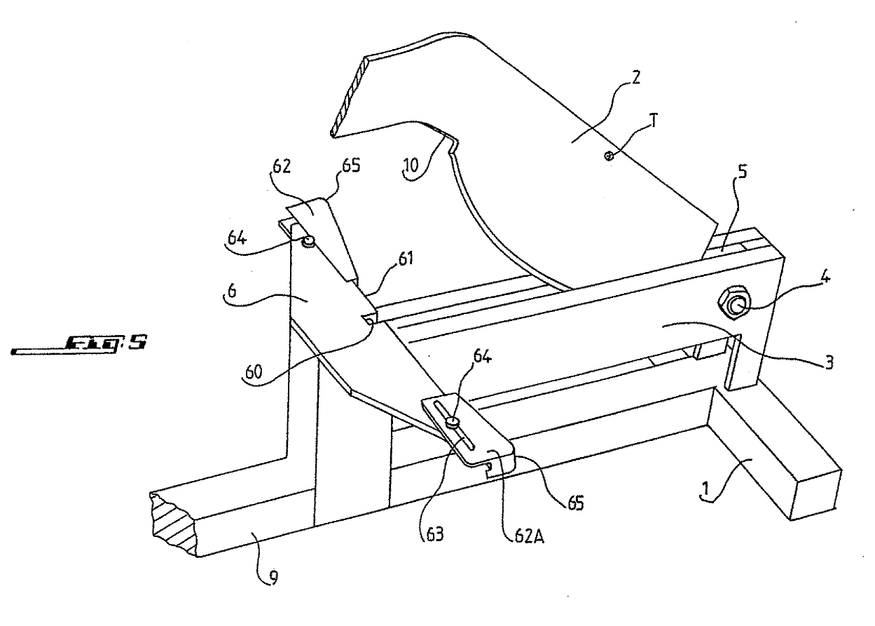

FIG. 5 shows the tool of FIG. 1 with a first cutting accessory,

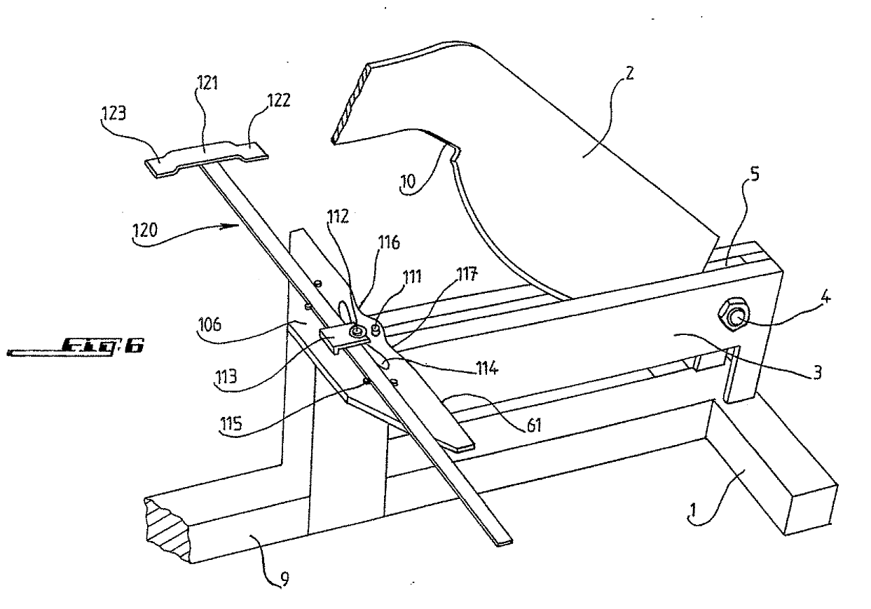

FIG. 6 shows a cutting tool according to a second embodiment of the invention, in half-open position,

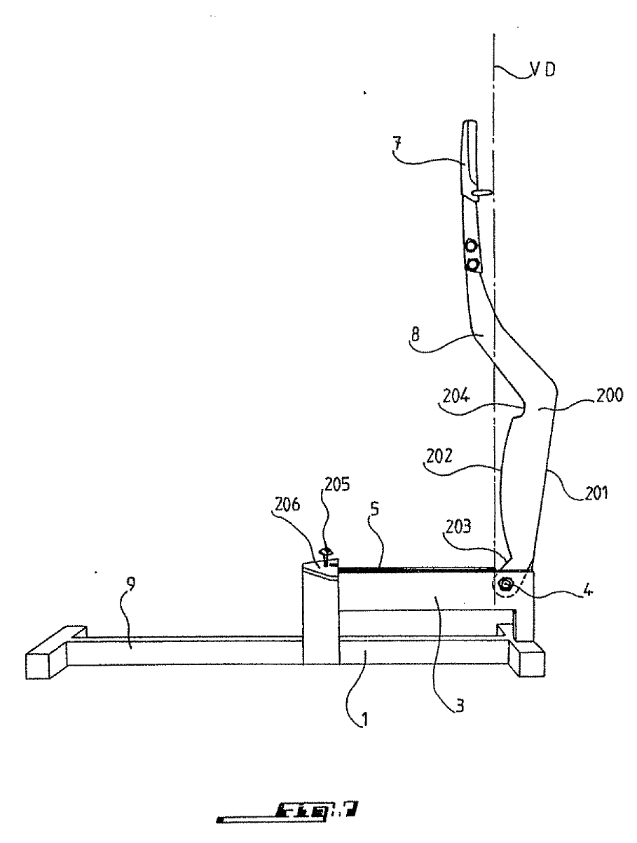

FIG. 7 shows a cutting tool according to a third embodiment of the invention,

FIG. 8 shows a cutting tool according to a fourth embodiment of the invention,

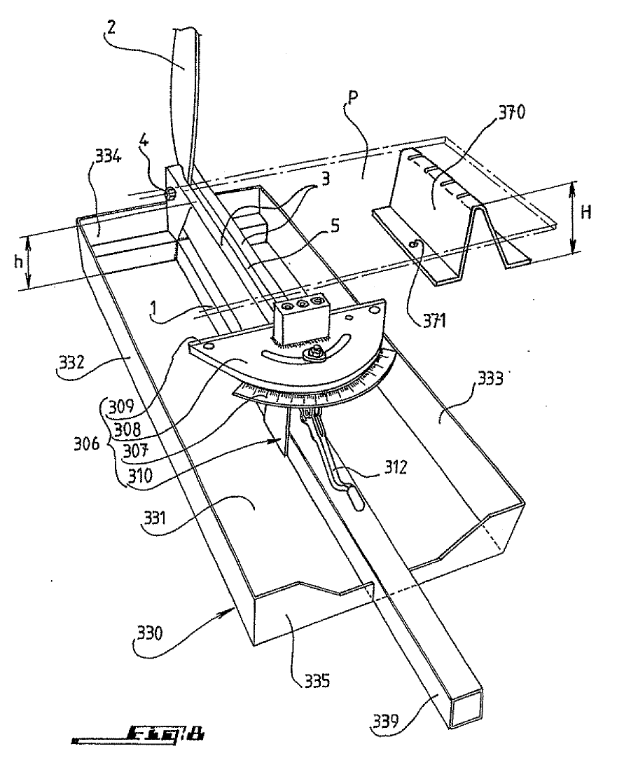

FIGS. 9 to 13 show detailed views of a clamping mechanism for the tool of FIG. 8,

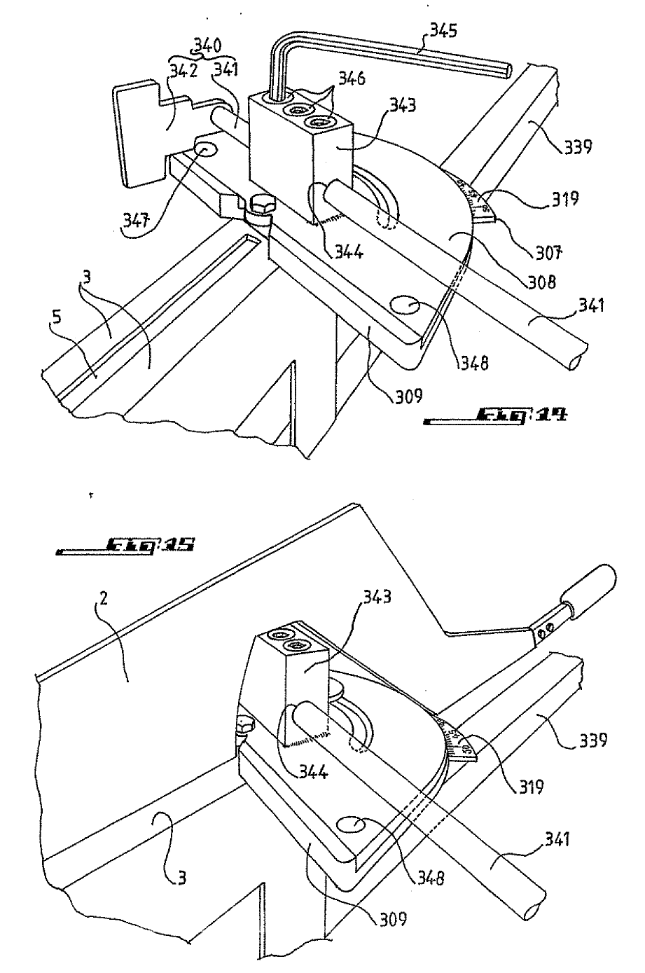

FIGS. 14 and 15 show detailed views of a first alternative embodiment of the cutting tool of FIG. 8,

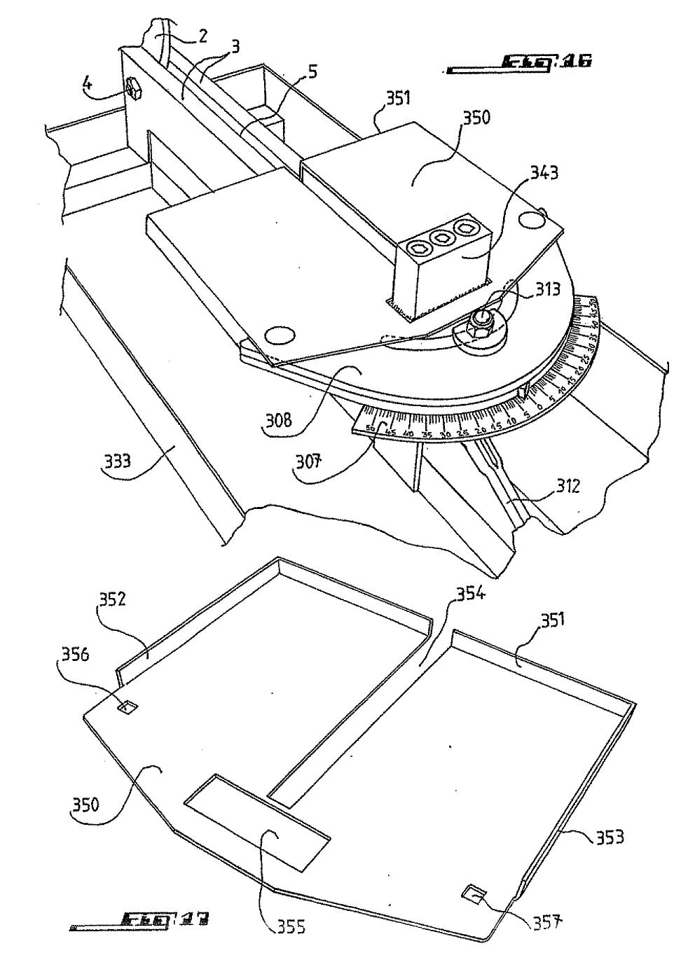

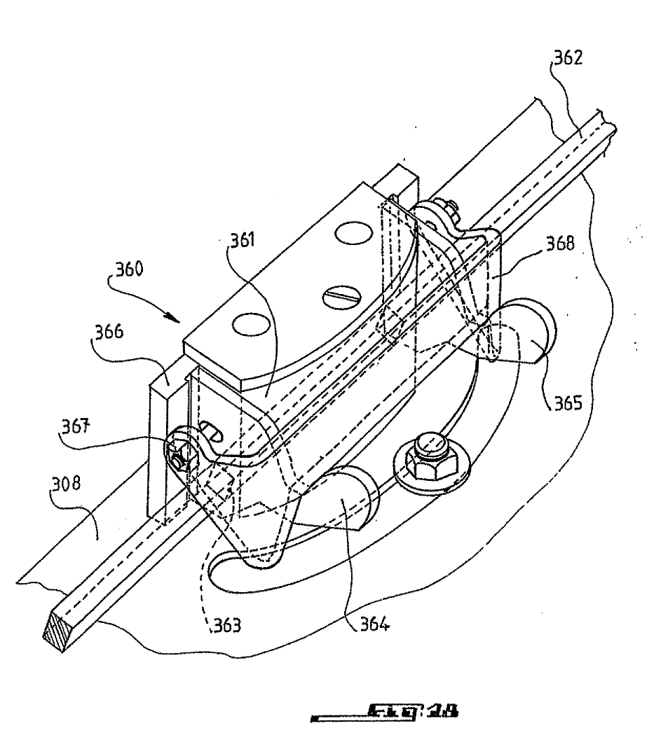

FIGS. 16 and 17 show detailed views of a second alternative embodiment of the cutting tool of FIG. 8, and

FIG. 18 shows a detailed view of a third alternative embodiment of the cutting tool of FIG. 8.

FIGS. 1 to 5 show a cutting tool according to a first embodiment of the invention, for cutting out a panel made of a reconstituted material. The tool includes a base 1 and a blade 2 mounted movably on a support 3 attached to the base. The blade 2 is mounted pivotally around a pin 4, which makes it possible to move the blade 2 between an open position for receiving, between the support and the blade, a panel made of a reconstituted material that is to be cut out, and a closed position at the end of the cutting operation. During cutting, the blade 2, together with the support 3, encloses an angle AC.

The blade 2 is formed with a back 21, a flat and curved cutting edge 22 and a stepped portion 23. While the function of the back 21 and the cutting edge 22 do not require explanation, it is appropriate to specify that the stepped portion 23 makes it possible to limit the travel of the blade 2 towards the open position. The open position of the blade 2 is reached when the stepped portion 23 comes to bear against the support 3.

The support 3 is provided with a slot 5 that is shaped so as to receive the blade 2 during cutting and with a transverse stop 6 intended to hold the panel being cut out during cutting. For the cutting operation, the panel being cut out is positioned on the support 3 and is brought to bear against the transverse stop 6. In this way, during the cutting operation, whenever the blade 2 has a tendency to drive the panel being cut out ahead of itself due to a relatively wide angle AC, and also due to the actual cutting action, the blade 2 ensures that the panel continues to bear against the transverse stop 6.

In order for the transverse stop 6 to be capable of fulfilling the dual mission assigned to it, i.e., to prevent the panel from being driven out of place by the blade 2 in the direction of cutting, and to hold the panel in an angularly stable position in order to enable a straight cut to be obtained, the transverse stop 6 must be wide. The width of the transverse stop 6 advantageously corresponds approximately to the length of the slot 5, preferably to the useful length LF of the slot 5.

The cutting edge 22 of the blade 2 is advantageously obtained via laser cutting. Producing the blade 2 in this way substantially introduces two advantages. The first of these is the possibility of obtaining a clean cutting edge in a single manufacturing step and in any predetermined shape. This is all the more advantageous when the cutting edge 22 is flat, and does not therefore need to be sharpened, as is shown in FIG. 4.

As a matter of fact, according to the arrangements of the invention, the blade 2 cooperates with the slot 5, and more precisely with the longitudinal edges of the slot, like two pairs of shears placed in parallel to one another. In this way, each of the two longitudinal edges of the cutting edge 22 of the blade 2, together with the corresponding longitudinal edge of the slot 5, form a pair of shears. Thus, as the cutting operation progresses, via a simultaneous shearing action as the blade 2 is lowered, each of the two pairs of shears detaches a corresponding half of what is removed, such as a strip of the material of which the panel being cut out is made.

Due to the thickness of the panels being cut out and, in particular in order to prevent the blade 2 from becoming jammed inside the slot 5 by the material being cut out, the width BF of the slot 5 is greater than the width BL of the blade 2. The difference between the width BF of the slot 5 and the width BL of the blade 2 is determined on the basis of the thickness of the panels to be cut out. To illustrate, in order to cut out panels having a thickness of approximately 7 mm, the difference between the two widths BF and BL is approximately 3 mm.

The curvature of the blade 2 is determined so that, in any instantaneous position of the blade during cutting, the angle AC enclosed between the support 3 and the blade 2 is at least approximately constant.

The blade 2 is provided with a handle 7 connected to the blade 2 by a lever-forming arm 8. A transitional portion 10 between the blade 2 and the arm 8 is shaped so as to come to bear against the stop 6 at the end of the cutting operation, and so to thereby limit the travel of the blade 2 towards its closed position. The closed position of the blade 2 is reached when the transitional portion 10 comes to bear against the stop 6.

The handle 7 is offset in relation to the back 21 of the blade 2 so that, at the end of the cutting operation, the handle 7 is situated at approximately the same level as the slot 5 or at a lower level thereto. FIG. 1 shows this arrangement by means of dotted lines ND and NF. Line ND is the extension of the back 21 of the blade 2 and line NF is the extension of the slot 5. The handle 7 of the blade 2 is offset in relation to line ND, and therefore in relation to the back 21 of the blade 2, by an angle that is sufficiently wide to obtain the following two results.

The first result, already mentioned above, is shown in FIG. 1: at the end of the cutting operation, the handle 7 is situated at a level lower than that indicated by line NF, thus lower than the level of the slot 5. It is obvious that the principle of this arrangement of the invention is also observed when, at the end of the cutting operation, the handle 7 is situated slightly above level NF. This becomes obvious by looking at the second result obtained by said arrangement.

The second result, which is more important than the first one but not as easy to see, is shown in FIG. 3: at the start of the cutting operation, also preferably when the blade 2 is in open position, the handle 7 is situated on the stop 6 side, in relation to the vertical VD originating at a point on the slot 5 marking the start of the cutting operation. It is specifically said to be “vertical” VD and not “perpendicular to the slot 5,” because it must be kept in mind that the tool of the invention is intended to be used substantially outside the workshop. The floor or any other bottom surface on which the tool will be placed will not necessarily be straight or horizontal everywhere. It is thus easy to conceive of situations where the tool will be placed on a bottom surface resistant to the forces produced during cutting, but which cannot ensure a horizontal position for the tool. Consequently, in order to facilitate initiation of the cutting operation, it is recommended that the handle 7 already be situated at the start of the cutting operation, in a position enabling a person using the tool to primarily use their weight to move the blade 2, instead of having to pull the blade towards themselves.

Furthermore, the base 1 of the tool according to the invention is extended in the direction of cutting by a foot 9 ensuring stability of the tool in the direction of cutting and in a transverse direction thereto. In one simple embodiment, the foot 9 consists of a T-section, as shown in FIGS. 1 to 3. One advantageous characteristic of the foot 9, regardless of its shape, is to enable the user of the tool to place their foot on the foot 9 of the tool and to be able to hold the tool during the entire cutting operation in a simple and secure manner, while at the same time leaving the user's hands free to handle the blade 2.

FIG. 5 shows the tool according to the first embodiment of the invention shown in FIGS. 1 to 4, with a first cutting accessory. The first cutting accessory comprises a distance stop 62 shaped so as to be fastened onto an edge 61 of the stop 6, the edge 61 being opposite the blade 2. The distance stop 62 is also shown twice, referenced as 62 and 62A, respectively, in order to show that it is reversible.

As a matter of fact, when installing a floating floor or covering panels for a floor or wall, corner irregularities are often detected. For example, the floor of a room is not truly rectangular. In a case such as this, it is a matter of being able to make cuts with angles so slightly different from a right angle that it would be difficult to properly adjust an angularly adjustable stop such as the one described above in reference to FIG. 6. Furthermore, it must be possible to make a cut such as this on one side of the panel as well as the other.

In order to have a stable support enabling the cutting angle to be varied very finely, the invention proposes the distance stop 62 that is provided with an oblong hole 63 in order to be fastened onto the stop 6 with a bolt 64. The oblong hole 63 makes it possible to fasten the distance stop, like distance stop 62 on one side of the stop 6 or like distance stop 62A on the other side of the stop 6, in various positions along the edge 61 of the stop 6. The panel being cut out is then supported by a center notch 60 of the stop 6 and by a rounded corner 65 of the distance stop 62. It is easily understood that the closer the distance stop 62 is brought towards the notch 60, the more the cut deviates from a right angle. The rounded shape of the corner 65 of the distance stop 62 prevents the area of the panel being cut out from being damaged.

According to a second embodiment of the invention shown in FIG. 6, in order to be able to also use the tool of the invention for cuts with angles very different from a right angle, the tool is equipped, as a variant of the stop 6 mounted fixedly at a right angle in relation to the blade 2, with a transverse stop 106 mounted movably on the support 3, so as to be capable of being set in various angular positions at the desired cutting angle, and at various distances from the pin 4 of the blade 2, depending on the dimensions of the panel being cut out.

To that end, the transverse stop 106 includes a guide rod 111 and a bolt 112, both pass through the transverse stop 106 and beyond it on both faces of the stop. While the guide rod 111 serves solely to guide the stop 106 during its movements along the slot 5, and does not therefore need to be long, the bolt 112 serves both to guide the transverse stop 106 during its movements along the slot 5 and, together with a curved opening 114 made in the stop 106, when setting a cutting angle, to fasten it in a chosen position. To that end, the bolt 112 includes a screw that is sufficiently long so that its end is capable of sliding and coming to bear against the inside face of the support 3, on either side of the slot 5, and so that the body of the screw is capable of passing through the slot 5 and the transverse stop 106 and of going beyond the upper face of the latter by a length sufficient to be able to position the nut.

The transverse stop 106 is advantageously but not compulsorily equipped with a slider 120 made in the shape of a T and mounted parallel in relation to the edge 61 of the transverse stop 106 opposite the blade 2. The slider 120 is guided on the transverse stop 106 by lugs 115 protruding from both faces of the stop 106, and is fastened onto the transverse stop 106 by a clamp 113, which is itself pressed against the slider and the stop by the bolt 112 when it is tightened.

The slider 120, the T-shape of which is obtained via integration of a crosspiece 121 having two opposite ends 122, 123, serves as a lateral stop and support for the reconstituted material being cut out, when the material is cut out at a angle other than 90°. Because, in such a case, the orientation of the transverse stop 106 is at the origin of a resolution of the thrust of the blade into a longitudinal component, according to the orientation of the slot 5, and a transverse component to the right or to the left of the slot 5, according to the orientation of the edge 61 of the stop 106. And it is this transverse component that it is a matter of countering by the presence of a lateral stop 122 or 123, depending on whether the slider 120 is oriented towards the right, as is shown in FIG. 6, or in the opposite direction.

The arrangement according to which the guide rod 111, the bolt 112 and the lugs 115 protrude from the two faces of the transverse stop 106 makes it possible to use the transverse stop 106 both on the front side as well as the back side. This is particularly advantageous when the curved opening 114 is not symmetrical, in order to enable a wide enough range of cutting angles without thereby weakening the transverse clamp 106 by too long of an opening 114.

In order to ensure the best possible support for a panel being cut out at an angle other than a right angle, the transverse stop 106 is provided with two notches 116, 117 on its face 61, which are asymmetrical in relation to one another.

FIG. 7 shows a tool according to a third embodiment of the invention. This third embodiment differs substantially from the first one by a blade 200 having a less curved cutting edge and the shape of which was determined so as to give the blade 200 a different open position from the open position of blade 2 of the first embodiment, and so as to integrate a stop 203 into the blade 200 on the side of the cutting edge. The characteristics of the third embodiment that are identical to those of the first embodiment bear the same reference numbers.

The blade 200 is formed with a back 201, a cutting edge 202 that is flat but less curved than blade 2, a first stop 203 formed between the cutting edge 202 and the pin 4, whereby the blade 200 is mounted on the support 3, and a second stop 204 formed between the blade 200 and the arm 8. While the function of the back 21 and the cutting edge 22 do not require explanation, it is appropriate to specify the functions of the two stops 203 and 204.

Blade 200 can be formed solely with the first stop 203 or both with the first stop 203 and the second stop 204, depending on the alternative embodiment selected for the second embodiment of the tool of the invention.

The blade 200 differs specifically from blade 2 of the first embodiment by the fact that the beginning of the cutting edge 202 is distanced from the support 3 and the slot 5 of the support 3 when the blade 200 is in open position. This is obtained by a different shape of each of the two ends of the blade through which the pin 4 passes. This end is shaped to form, at the same time, the pivot point of the blade, a raising element for the blade in relation to the pin 4 when the blade is in open position and at the start of the cutting phase, and a stop 203 against which a panel being cut out is pressed.

As a matter of fact, in a manner similar to the situation of the blade 2 of the first embodiment, the blade 200 drives the panel that it is supposed to cut out, due to the angle that the blade encloses together with the support 3. Since, together with the support 3, the blade 200 encloses a clearly smaller angle that does blade 2, and since, at the start of the cutting operation, this angle is turned towards the pin 4, the vertical component of the bearing force exerted by the blade 200 is, from the start of the cutting operation, sufficiently strong to immobilize the panel. It is possible, in particular when the thickness of the panel is less than what corresponds to the height of the stop 203, for the blade rather to have a tendency to drive the panel towards the pin 4. It is therefore unnecessary to provide for a stop 206 on the support 3.

On the other hand, when panels must be cut out at an angle other than a right angle, the stop 203 of the blade 200 cannot ensure accurate positioning of the panel. Use must therefore be made of a stop 206 mounted movably by means of a bolt 205, this stop corresponding substantially to the stop 106 of the first embodiment. In order to not reduce the travel of the blade 200 by the protruding bolt 205, the blade 200 comprises a cut-out portion 204 that comes to bear against the bolt 205 when the blade 200 has reached the closed position.

FIG. 8 shows a tool according to a fourth embodiment of the invention. This tool corresponds to that of the second embodiment of the invention (see FIG. 6) to the extent that the tool includes a base 1 and a blade 2 mounted movably on a support 3 attached to the base 1. The blade 2 is mounted pivotally around the pin 4 so that it is capable of being moved between an open position for receiving a panel being cut out and a closed position at the end of the cutting operation. The support 3 is provided with a slot 5 shaped to receive the blade 2 during cutting.

The tool according to the fourth embodiment of the invention is shown with a tray 330 intended to collect cutting splinters and debris, and a foot 370 intended to support the free end of a panel P being cut out, e.g., a floorboard or a baseboard.

The tray 330 is intended to receive the particles and pieces that become detached from the panel being cut out. To that end, the tray 330 includes a bottom 331, two longitudinal rims 322, 323 and two transverse rims 334, 335. The tray 330 is advantageously formed from a single metal sheet via folding, with a width such that the base 1 can be inserted without an appreciable clearance for the crosspiece of the base 1. In order for it to be possible to limit the length of the tray 330 approximately to the length of the blade 2, and in particular without taking account of the length of the base 1 and its extension 339 described earlier, the transverse rim 335 is provided with a cut-out enabling the base 1 to be inserted therein. The tray 330 can be made integral with the base 1 of the tool of the invention, so as to be an integral part of the tool, or separately, as if it were an accessory. Without deviating from the principle of this invention, the tray 330, as an integral part or accessory, can also form part of one or another of the first to third embodiments of the tool of the invention.

Together with the support 3, the foot 370 is intended to support a panel P being cut out. More precisely, the foot 370 is intended to support the free end of the panel P and to hold it at a level H higher than the height h of the upper face of the support 3. Owing to this arrangement of the invention, the panel P will be held in such a way as to obtain a slightly beveled edge and to thereby compensate for the inevitable tear-offs from the edge of the rear face of the panel. The foot 370 can be made as an integral part of the tool of the invention, and for that matter of any of the first to fourth embodiments of the invention, or as an accessory part. The separate part alternative has an advantage in that the foot 370 can be placed at any useful distance from the support 3 of the tool, without being limited by a link rod, even distance-adjustable, or by any other element whereby the foot would be mounted integral with the base 1 or with the support 3 of the tool of the invention.

When the foot 370 is made as a separate part, it advantageously comprises a hole 371 owing to which, during transport of the tool, it can be bolted to the blade 2, for this purpose, is provided with a hole T (see FIG. 5).

The tool according to the fourth embodiment differs from the one according to the second embodiment by the fact that the base 1 is extended in the direction of cutting by a foot 339 in the form of a straight rectangular section ensuring stability of the tool in the direction of cutting. The base 1 and foot 339 assembly thus forms a three-point and not a four-point base as in the first and second embodiments of the invention. A three-point base can provide better stability than a four-point base when the support or the ground on which the tool is positioned for the cutting operation is very uneven.

Furthermore, as an alternative to the stop 6 mounted fixedly at a right angle in relation to the blade 2 in the first and second embodiments, the tool according to the fourth embodiment is equipped with a transverse stop 306 mounted movably on the support 3 so as to be capable of being fastened in various angular positions at the desired cutting angle. However, unlike the transverse stop 106 of the second embodiment, the transverse stop 306 cannot be mounted at various distances from the pin 4 of the blade 2. The variable distance of the transverse stop is achieved in the fourth embodiment by a third accessory 350 described later on.

The transverse stop 306 includes a graduated support 307 integral with the support 3, a plate 308 with a straight edge 309 forming a transverse stop and a clamping mechanism 310 making it possible to stop the plate 308 in various angular positions.

FIG. 9 shows the clamping mechanism 310, as a detailed view of the transverse stop 306 of the tool according to the fourth embodiment of the invention. The graduated support 307 is a part made in the image of a protractor, i.e., it comprises a graduated scale to the nearest angular degree arranged along a curved edge. This graduated scale covers a range of approximately fifty degrees on each side of the center line of the slot 5. Since the support 307 is integral with the support 3, the zero degree mark therefore indicates the orientation of the cut when a rectangular cut is being made.

So as to be angularly movable, the stop-forming plate 308 is provided with an arc-of-circle-shaped slot 311, the length 4 of which is chosen so as to be able to move this plate 308 over the entire range of the graduated scale of the support 307.

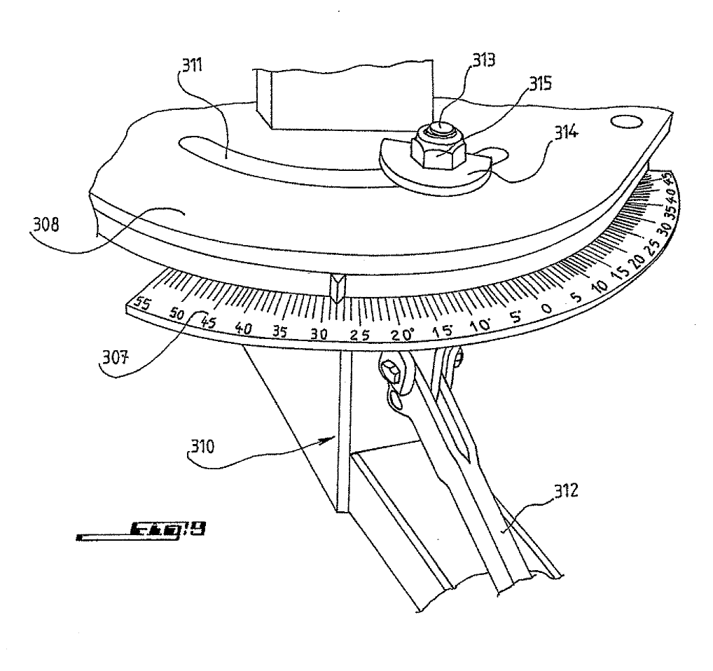

In order to be able to easily immobilize the plate 308 in a selected angular position, the tool comprises a knuckle joint mechanism 310 shaped to be capable of clamping and unclamping the plate 308 in relation to the support 307, by means of the action of a lever 312 and a pin 313 placed in axial translation by the action of the lever. As FIG. 9 leaves to be assumed, and as FIG. 10 shows in greater detail, the plate 308 is clamped against the support 307 when the lever 312 of the clamping mechanism 310 is lowered and, as shown in FIG. 11, the plate 308 is unclamped from the support 307 when the lever 312 is raised.

Besides the lever 312 and the pin 313, the clamping mechanism of the tool according to the fourth embodiment of the invention includes a washer 314 and a lock nut 315. The mechanism 310 is mounted beneath the support 307 such that the pin 313 again crosses the support 307 via a through-hole, and the stop-forming plate 308 via the slot 311, and protrudes from the plate 308 upwardly over a length sufficient to be able to thread the washer 314 over and tighten the lock nut 315 on the threaded pin 313. The locking nature of the nut 315 threading is necessary in order to be able to adjust the position of the nut 315 on the threaded pin 313 and thereby the clamping force exerted at the moment when the lever 312 is lowered and when the threaded pin 313, washer 314 and nut 315 assembly pulls the plate 308 downward and clamps it against the graduated support 307.

FIG. 10 shows the clamping mechanism of the tool according to the fourth embodiment, in clamping position. And it is seen more specifically here that the plate 308 is indeed bearing against the graduated support 307, and a conventional knuckle joint mechanism is recognized here whereby the lever 312 is connected to the pin 313 in order to be able to move it in axial translation.

FIG. 11 shows the clamping mechanism of the tool according to the fourth embodiment, in unclamped position. In FIG. 11, it is specifically seen that when the plate 308 is entirely unclamped, it is at the same time raised in relation to the graduated support 307, and the washer 314 and nut 315 are still bearing against the plate 308.

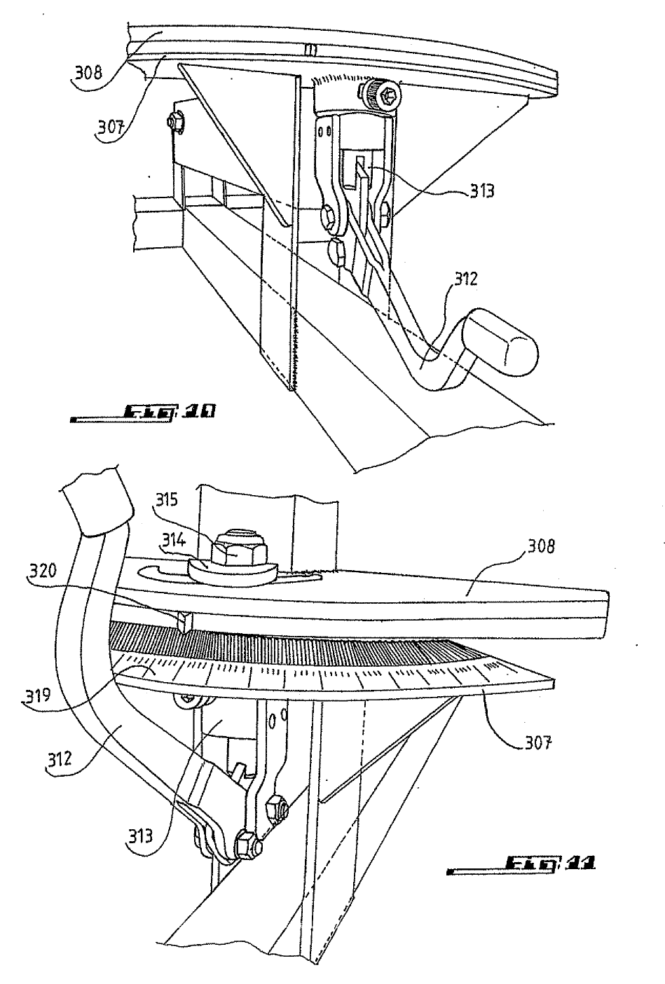

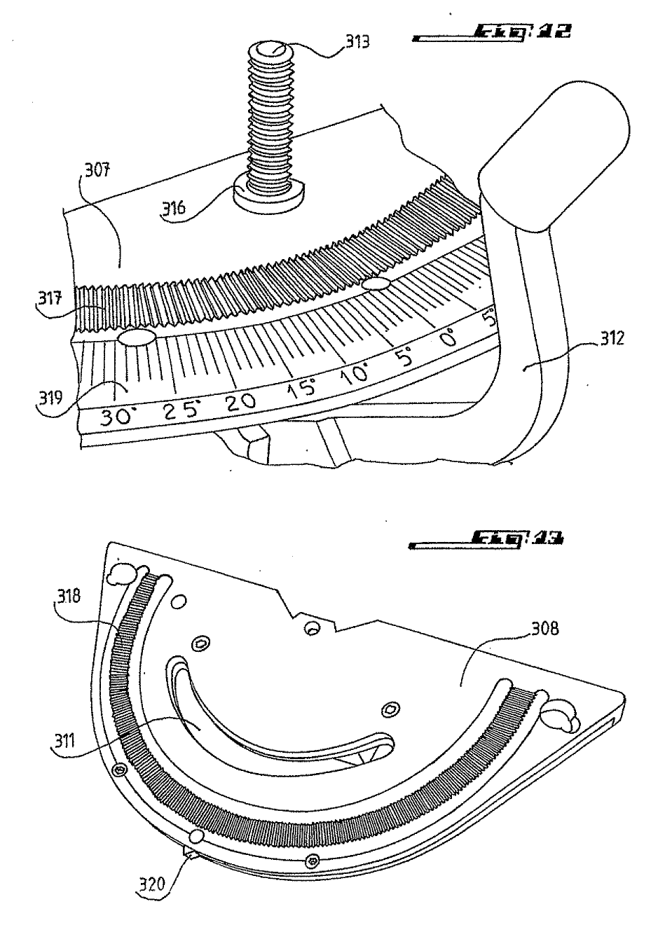

As shown in FIGS. 12 and 13, this alternating clamping and unclamping action by respectively lowering and raising the plate 308 is obtained by the following means. The pin 313 comprises a lower portion, seen in the direction of mounting the tool of the invention, with a first diameter and a threaded upper portion with a second diameter, which is smaller than the first. The difference between the first diameter and the second diameter is chosen so that a circular shoulder 316 forming a transition between the lower portion and the upper portion of the pin 313 is sufficiently large to hold the plate 308. Thus, when the lever 312 of the clamping mechanism 310 is lowered, the pin 313 is situated in its lower position and, specifically, the lower portion of the pin 313 is housed entirely within the graduated support 307. On the other hand, when the lever 312 is in its entirely raised position, the pin 313 is in its upper position, as is shown in FIG. 12, and the lower portion of the pin 313 protrudes from the graduated support 307 by a height sufficient to hold the plate 308 overhead in relation to the graduated support 307, so that angular movement of the plate 308 is easily possible. In other words, the plate 308 is fastened onto the upper portion of the pin 313 so that it is pushed upwards by the circular shoulder 316 of the pin 313, when it is a matter of separating the graduated support 307 and the plate 308. Conversely, the plate 308 is pulled downwards by the washer 314 and the nut 315, in order to come to bear against the graduated support 307, when the pin 313 is moved axially downward.

In order to obtain a more precise angular orientation of the plate 308, and of the stop 309 in particular, although this is not the case with the device of the invention produced according to FIG. 6, the graduated support 307 and the plate 308 are provided, on each of the two opposite faces, with a series of notches arranged in an arc of a circle and covering the anticipated orientation range. Owing to these notches 317 on the graduated support 307 and to the notches 318 made on the plate 308, and owing to the division of these complementary notches into fine notches, it is possible to adjust the orientation of the transverse stop 309 to at least the nearest degree. Reading the orientation of the transverse stop 309 on the graduated scale 319 of the graduated support 307 is facilitated by means of an index 320 produced in relief on the edge of the plate 308, as is shown in FIGS. 11 and 13.

As a first alternative embodiment of the tool according to the fourth embodiment of the invention, FIGS. 14 and 15 show a slider 340. Recall that, in this context, the cutting tool according to the second embodiment of the invention includes a slider 120 arranged parallel to the transverse stop 61 so as to be able to prevent a panel being cut out from being driven out of place by the blade during cutting, as explained above.

Similarly, the cutting device of the invention according to the fourth embodiment of the invention includes a slider 340 comprising a rod 341 and a stop 342. The rod 341 is advantageously a solid body or a hollow cylindrical element and, in any case, of cylindrical cross section. The stop 342 is a stepped plate mounted transversely in relation to the rod 341 and having a shape in the form of cut-outs according to the dimensions of the plate 308. The cut-outs are made so that the stop 342 can be brought as close as possible to the blade 2.

The slider 340 is shaped to be fastened on the plate 308 by means of a parallelepiped-shaped locking element 343 mounted integral on the plate 308 and comprising a cylindrical passage 344 into which the slider 340 is slidably inserted. In order to be able to stop the slider 340 in a precise lateral position, the parallelepiped-shaped locking element 343 comprises at least one, preferably two or, as shown in FIG. 14, three locking screws 346. Thus, depending on the orientation given to the plate 308 and in particular to the transverse stop 309, the slider 340 is inserted into the locking element 343 by the right or the left side, respectively, so that, in relation to the graduated scale 319 of the graduated support 307, the stop 342 is situated on the side opposite the graduated scale on which the index 320 is placed. In this way, it is ensured that the slider 340 forms a support for the panel being cut out, so as to prevent the panel from moving laterally outward due to the thrust exerted by the blade 2.

FIG. 15 further shows that the locking element 343 is advantageously shaped to serve as a stop for the blade 2. As a matter of fact, as shown in FIG. 15, the blade 2 comes to bear against the fastening element 343 when it is at the end of the cutting operation.

Locking the rod 341 of the slider 340 in a selected lateral position is carried out by means of the three screws 346 that do not protrude from the horizontal upper face of the fastening element 343 when they are tightened. The tightening and loosening of the three screws 346 is carried out by means of an Allen wrench 345 or any other tool suited to the shape of the screw heads. To store the wrench 345, for example, either of the two orifices 347, 348 made in the plate 308 can be used.

FIGS. 16 and 17 show detailed views of a second alternative embodiment of the cutting tool of the invention, intended specifically for cutting out strips of narrower width.

Let us recall that the second embodiment anticipates not only a variable orientation of the transverse stop, but also its movement along the support 3 in order to be able to move the transverse stop relatively closer to or further from the pivot pin 4 of the blade 2. Thus, as practical experience with this type of tool demonstrates, it is possible to position the transverse stop so as to make the cut at the beginning of the movement of the blade 2 and not near the end thereof.

The fourth embodiment of the tool of the invention does not offer this possibility. As compensation, the fourth embodiment anticipates a third cutting accessory in the form of a plate 350 forming an auxiliary transverse stop 351. The plate 350 includes two lateral edges 352, 353 and a transverse edge 351 forming at the same time a transverse stop. The plate 350 further includes a slot 354 extending over the greater portion of the length of the plate and thereby offering the space necessary for the blade 2 to be able to penetrate into the slot 5 of the support 3. The plate 350 is intended to be placed on the plate 308 as is shown in FIG. 16, and, to that end, includes a rectangular cut-out 355, the dimensions of which correspond to that of the fastening element 343. In order to fasten plate 350 onto plate 308 plate 350 includes two orifices 356, 357 arranged so as to be superimposed over the orifices 346, 347 of plate 308 when plate 350 must be mounted on plate 308. The actual fastening of plate 350 is carried out with screws and nuts passing through holes 346, 357 and holes 347, 356, respectively.

FIG. 17 shows that the holes 356, 357 are advantageously made as square holes, which makes it possible to insert therein stove bolts that facilitate tightening of the nuts. It is obvious that any other type of screw/nut assembly can also be used without deviating from the principle of this invention.

FIG. 18 shows a third alternative embodiment of the fourth embodiment of the tool of the invention, namely an alternative for the parallelepiped-shaped element 343 (see FIGS. 14, 15) of the fourth embodiment of the invention, whereby a slider 340 is fastened onto the tool of the invention. According to this third alternative embodiment, the locking element 360 includes a body 361 mounted integral with the plate 308 and a locking member making it possible to lock a slider 362 in various positions, in a manner similar to the positioning of the slider 340 described above. The body 361 includes a channel 363 inside of which the slider 362 is slidably housed. In order to lock the slider in a selected position, the locking member includes two tabs 364, 365 mounted tiltably on a holding plate 366 integral with the body 361 and held apart by one or more resilient elements, preferably by a coil spring traversed by a pin 367 with nuts, whereby the toggling or tilting motion of the tabs 364, 365 is limited.

When the slider 362 is put into place, it passes through the two tabs 364, 365 via holes provided for this purpose and the body 361 via the channel 363. In the spread-apart position of the tabs, the slider is locked. Consequently, in order to unlock the slider and to move it, it is necessary to press on the two tabs so as to tilt them towards one another.

In order to facilitate positioning of the slider, in particular when a panel being cut out is already placed on the tool, the tabs 364, 365 can be held in a close-together position, in order to enable the slider to slide inside the channel 363, by means of a flap 368 designed for this task. FIG. 18 shows the locking member with the flap 368 in the position making it possible to hold the tabs close together.

1. A cutting tool for cutting a panel, the tool including:
a base;
a support attached to the base; and
a blade mounted movably on the support so the blade can be moved between an open position for receiving, between the support and the blade, a panel to be cut, and a closed position reached upon ending of a cutting operation, wherein
the support includes a slot for receiving the blade during cutting,
the blade has a back and a curved cutting edge, and
the support comprises a transverse stop for holding a panel on the support during cutting and preventing the panel from being driven out of place by the blade in the direction of cutting.

2. The tool according to claim 1, wherein the cutting edge of the blade is obtained by obtained by laser-cutting.

3. The tool according to claim 1, wherein the curved blade has a curvature determined so that, in any instantaneous position of the blade during cutting, an angle enclosed between the support and the blade is approximately constant.

4. The tool according to claim 1, wherein the slot has a width larger than width of the blade.

5. The tool according to claim 1, wherein the stop is a separate element mounted on the support.

6. The tool according to claim 1, wherein the stop is built into the blade.

7. The tool according to claim 5, wherein the stop is integral with the support and is perpendicular to the support.

8. The tool according to claim 5, wherein the stop comprises an adjustable distance stop for making cuts at various angles.

9. The tool according to claim 5, wherein the stop is a separate element and is angularly variable on the support.

10. The tool according to claim 9, wherein the stop comprises a movable T-shaped slider for supporting the material to be cut.

11. The tool according to claim 1, wherein the base includes a foot extending in the direction of cutting for stabilizing the tool in the direction of cutting and in a direction transverse to the cutting direction.

12. The tool according to claim 1, wherein the blade includes a handle and a lever forming arm connecting the handle to the blade.

13. The tool according to claim 12, wherein a transitional portion extending from the blade to the arm is shaped to bear against the stop, at the end of a cutting operation, and thereby limit travel of the blade towards the closed position.

14. The tool according to claim 1, wherein the blade includes a handle that is offset in relation to the back of the blade, so that, at the end of a cutting operation, the handle is located no higher than approximately the same level as the slot.

15. The tool according to claim 7, wherein the stop comprises an adjustable distance stop for making cuts at various angles.
